(19) United States
(12) Patent Application Publication
(10) Pub. No.: US 2014/0257824 A1
(43) Pub. Date: Sep. 11, 2014

(54) APPARATUS AND A METHOD FOR ENCODING AN INPUT SIGNAL

(71) Applicant: Huawei Technologies Co., Ltd., Shenzhen (CN)

(72) Inventors: Anisse Taleb, Kista (SE); Jianfeng Xu, Shenzhen (CN); David Virette, Munich (DE)

(73) Assignee: Huawei Technologies Co., Ltd., Shenzhen (CN)

(21) Appl. No.: 14/285,976

(22) Filed: May 23, 2014

Related U.S. Application Data
(63) Continuation of application No. PCT/EP2011/071021, filed on Nov. 25, 2011.

(51) Int. Cl. G10L 19/00

(52) U.S. Cl. CPC G10L 19/00
USPC 704/500

(57) ABSTRACT

An apparatus and a method for encoding an input signal applied to the apparatus comprising: a transient detector adapted to detect whether the applied input signal comprises a transient; at least two transient signal encoders adapted to encode the applied input signal if a transient is detected by the transient detector; and a selection unit adapted to select a transient signal encoder among the transient signal encoders according to at least one predetermined selection criterion.

### CROSS-REFERENCE TO RELATED APPLICATIONS

This application is a continuation of International Application No. PCT/EP2011/071021, filed on Nov. 25, 2011, which is hereby incorporated by reference in its entirety.

### TECHNICAL FIELD

The invention relates to an apparatus and a method for encoding an input signal and in particular an audio signal.

### BACKGROUND

In a conventional audio digital signal communication system a digital signal is compressed at an encoder and the compressed information, i.e. bit stream, is then packetized and sent to a decoder through a communication channel frame by frame. An entity comprising an encoder and a decoder is also called a codec unit. The term “coding” comprises the encoding and the corresponding decoding. Audio compression may be used to reduce the number of bits that represent the respective audio signal, thereby reducing the bandwidth and/or bit rate needed for data transmission through the communication channel. However, audio compression of a signal may result in perceived quality degradation of the decompressed signal on the receiver side. In general, transmission of data with a higher bit rate results in a decoder signal of higher quality while transmission of a signal with a lower bit rate results in a decoded signal of lower quality.

In a conventional audio digital signal communication system a classification of the input signal is often performed to improve the coding efficiency. One possible way to classify the input signal is to distinguish between stationary signals and transient signals. A transient is generally defined as a sudden change in the input signal which occurs for a short period of time. A transient signal is usually characterized by a fast change in signal power and amplitude. This fast change can represent for example a so-called attack by instruments such as drums or simply the start of a talk spurt. A transient usually contains a high degree of non-periodic components and a higher magnitude of high frequency content. In general, transients are difficult to encode and some of the conventional signal coding models are not well adapted to this kind of signals. Accordingly, for encoding a transient signal a codec may adapt the coding model to the characteristics of such an input signal.

FIG. 1 shows a block diagram of a conventional audio encoder comprising a transient detector. At the encoder side the transient detector detects whether the current input signal is a transient signal or not. The encoder does use a stationary mode encoder in case of a non-transient signal and a transient mode encoder if the input signal is a transient signal. Accordingly, with the conventional audio encoder with a transient detector as shown in FIG. 1 the transient detector is used to detect the transient signal and then according to the result of this first stage a proper coding model is selected to encode the input signal. This selected coding model can then be signaled to the decoder by means of a transient flag multiplexed into the bit stream by a multiplexer as shown in FIG. 1. There are different transient signal coding methods known such as window switching. Another example of transient encoding similar to window switching is based on a short window DCT. In the conventional audio encoder with a transient detector as shown in FIG. 1 the apparatus applies stationary coding to stationary signals and transient coding to transient signals to improve the quality of the coding. However, the efficiency and quality of coding, i.e. encoding and decoding, a transient signal can vary dependent on the nature and position of the respective transient signal. Accordingly, there is a need to provide an apparatus and a method for encoding facilitating an improved encoding and decoding of transient signals.

### SUMMARY

The invention provides according to a first aspect an apparatus for encoding an input signal applied to said apparatus, the apparatus comprising:

a transient detector adapted to detect whether the applied input signal comprises a transient;

at least two transient signal encoders adapted to encode the applied input signal if a transient is detected by said transient detector; and

a selection unit adapted to select a transient signal encoder among the at least two transient signal encoders according to at least one predetermined selection criterion.

In a first implementation of the apparatus for encoding an input signal according to the first aspect of the present invention the transient detector is adapted to detect a transient position of a transient of the input signal applied to said apparatus.

In a further possible second implementation of the apparatus according to the first aspect of the present invention the transient detector is adapted to detect a transient energy of a transient of the input signal applied to said apparatus.

In a further possible third implementation of the apparatus according to the first aspect of the present invention the transient detector is adapted to detect a transient position and a transient energy of a transient of the input signal applied to said apparatus.

In a further possible fourth implementation of the first to third implementation of the apparatus according to the first aspect of the present invention a selection unit is adapted to perform a closed loop selection of said transient signal encoder.

In an alternative fifth implementation of the first to third implementation of the apparatus for encoding an input signal according to the first aspect of the present invention the selection unit is adapted to perform an open loop selection of said transient signal encoder.

In a possible sixth implementation of the fourth implementation of the apparatus for encoding an input signal according to the first aspect of the present invention the selection unit is provided for performing a closed loop selection by selecting the transient signal encoder within a codec unit comprising the transient signal encoder and a corresponding transient signal decoder which supplies the selection unit with the decoded transient signal having the highest signal quality.

In a further possible seventh implementation of the fifth implementation of the apparatus for encoding an input signal according to the first aspect of the present invention the selection unit is provided for performing an open loop selection by selecting the transient signal encoder among the at least two transient signal encoders depending on the transient position of the applied input signal detected by said transient detector.

In a further possible eighth implementation of the fifth implementation of the apparatus for encoding an input signal according to the first aspect of the present invention the selection unit is provided for performing an open loop selection by selecting the transient signal encoder among the transient signal encoders depending on the transient energy of the applied input signal detected by said transient detector.

In a further possible ninth implementation of the fifth implementation of the apparatus for encoding an input signal according to the first aspect of the present invention the selection unit is provided for performing an open loop selection by selecting the transient signal encoder among the at least two transient signal encoders depending on the transient position and the transient energy of the applied input signal detected by said transient detector.

In a possible tenth implementation of the first to ninth implementation of the apparatus for encoding an input signal according to the first aspect of the present invention the at least two transient signal encoders are adapted to perform the encoding of the input signal by using different transient encoding mechanisms or algorithms.

In a possible eleventh implementation of the tenth implementation of the apparatus for encoding an input signal according to the first aspect of the present invention the different transient encoding mechanisms used by the at least two transient signal encoders comprise window switching, short window DCT or are based on transient parameters, sinusoidal parameters and time/frequency envelope extraction.

In a further possible twelfth implementation of the first to eleventh implementation of the apparatus for encoding an input signal according to the first aspect of the present invention the at least one selection criterion used by said selection unit comprises a signal to noise ratio SNR.

In a further possible thirteenth implementation of the first to eleventh implementation of the apparatus for encoding an input signal according to the first aspect of the present invention the at least one selection criterion used by said selection unit comprises a segmental signal to noise ratio SSNR.

In a further possible fourteenth implementation of the first to eleventh implementation of the apparatus for encoding an input signal according to the first aspect of the present invention the at least one selection criterion used by said selection unit comprises a weighted segmental signal to noise ratio WSSNR.

In a further possible fifteenth implementation of the first to eleventh implementation of the apparatus for encoding an input signal according to the first aspect of the present invention the at least one selection criterion used by said selection unit comprises a pre-echo signal energy.

In a further possible sixteenth implementation of the fourteenth implementation of the apparatus for encoding an input signal according to the first aspect of the present invention the selection unit is adapted to calculate the weighted segmental signal to noise ratio WSSNR using a weighting function stored in a local memory of said apparatus.

In a further possible seventeenth implementation of the sixteenth implementation of the apparatus for encoding an input signal according to the first aspect of the present invention the weighting function applies different weighting factors before and after the detected transient position detected by said transient detector.

In a possible eighteenth implementation of the first to seventeenth implementation of the apparatus for encoding an input signal according to the first aspect of the present invention the apparatus comprises a non-transient signal encoder adapted to encode the input signal if the transient detector does not detect a transient in said input signal. The non-transient signal encoder can be a stationary signal encoder.

In a possible nineteenth implementation of the first to eighteenth implementation of the apparatus for encoding an input signal according to the first aspect of the present invention the transient detector generates a transient indication, for example a transient flag, indicating whether a transient has been detected by said transient detector or not.

In a possible twentieth implementation of the first to nineteenth implementation of the apparatus for encoding an input signal according to the first aspect of the present invention the selection unit is adapted to control a switch to select a transient signal encoder among the at least two transient signal encoders according to the at least one predetermined selection criterion.

In a further possible twenty-first implementation of the nineteenth or twentieth implementation of the apparatus for encoding an input signal according to the first aspect of the present invention the apparatus further comprises a multiplexer adapted to multiplex the encoded transient signal output by the selected transient signal encoder or the encoded non-transient signal, and the transient indication, for example a transient flag, generated by said transient detector onto a communication channel.

In a possible twenty-second implementation of the first to twenty-first implementation of the apparatus for encoding an input signal according to the first aspect of the present invention the selection unit generates a transient type indication, for example a transient type indicator, indicating the type of the selected transient signal encoder or codec.

In a possible twenty-third implementation of the twenty-second implementation of the apparatus for encoding an input signal according to the first aspect of the present invention, the apparatus further comprises a multiplexer adapted to multiplex the encoded signal, encoded by one of the at least two transient encoders, and the transient type indication associated to the transient encoder selected for encoding the input signal onto a communication channel or into an output bitstream or datastream.

The invention further provides according to a second aspect a method for encoding an input signal, the method comprising the steps of:

detecting whether the input signal comprises a transient; and

selecting a transient signal encoder among a group of transient signal encoders according to at least one predetermined selection criterion if a transient is detected in said input signal.

In a possible first implementation of the method for encoding an input signal according to the second aspect of the present invention the selecting of the transient signal encoder is performed in a closed loop selection.

In a further possible second implementation of the method for encoding an input signal according to the second aspect of the present invention the selecting of the transient signal decoder is performed as an open loop selection of said transient signal encoder.

According to a third aspect, the invention provides an apparatus for decoding, the apparatus comprising:

a receiver adapted to receive an encoded transient signal and a transient type indication, wherein the transient type indication indicates a type of a transient coding;

at least two transient signal decoders; and

a selection unit to select a transient signal decoder among the at least two transient signal decoders based on the transient type indication to decode the encoded transient signal.

According to a fourth aspect, the invention provides an apparatus for decoding, the apparatus comprising:

a receiver adapted to receive an encoded signal, a transient indication and a transient type indication, wherein the transient indication indicates, whether the encoded signal is a transient signal or a non-transient signal, and wherein the transient type indication indicates a type of transient coding incase the transient indication indicates that the encoded signal is a transient signal;

at least two transient signal decoders; and

a selection unit to select a transient signal decoder among the at least two transient signal decoders based on the transient type indication to decode the encoded transient signal in case the transient indication indicates that the encoded signal is a transient signal.

In a first possible implementation of the apparatus for decoding according to the fourth aspect, the apparatus further comprises:

a non-transient decoder;

wherein the selection unit is further adapted to select the non-transient decoder to decode the encoded signal in case the transient indication indicates that the encoded signal is a non-transient signal.

According to a fifth aspect of the invention, a method for decoding is provided, the method comprising:

receiving an encoded signal, a transient indication and a transient type indication, wherein the transient indication indicates, whether the encoded signal is a transient signal or a non-transient signal, and wherein the transient type indication indicates a type of transient coding in case the transient indication indicates that the encoded signal is a transient signal; and

selecting a transient signal decoder among at least two transient signal decoders based on the transient type indicator to decode the encoded transient signal in case the transient indication indicates that the encoded signal is a transient signal.

The transient indication and the transient type indication of any of the previous aspects and their implementation forms can be separate or joint indications. In case of separate indications the transient indication can be a transient flag and the transient type indication can be a separate transient type flag or transient type indicator comprising several bits to distinguish the different transient codecs. In case of a joint indication the transient indication and the transient type indication, or the related information, are combined into one joint transient indicator or joint transient indicator field, wherein a first value of the joint transient indicator indicates that the encoded signal is a non-transient signal, a second value indicates that the encoded signal is a transient signal encoded according to a first transient codec, a third value indicates that the encoded signal is a transient signal encoded according to a second transient codec, and so on.

### BRIEF DESCRIPTION OF THE DRAWINGS

In the following possible implementations and embodiments of the apparatus and method for encoding an input signal according to the first and second aspect of the present invention are described with reference to the enclosed figures.

FIG. 1 shows a block diagram of a conventional audio encoder with a transient detector;

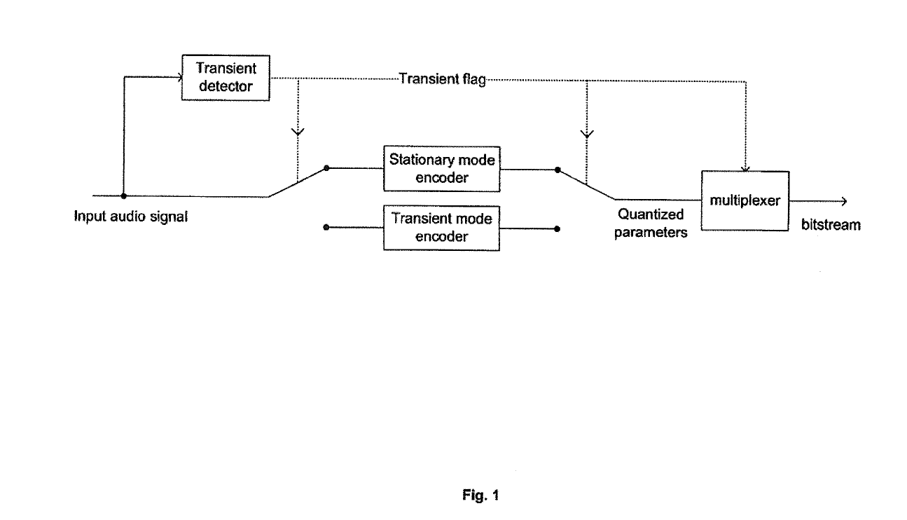

FIG. 2 shows a block diagram of a possible implementation of an apparatus for encoding an input signal according to the first aspect of the present invention;

FIG. 3 shows a block diagram of a further possible implementation of an apparatus for encoding an input signal according to the first aspect of the present invention;

FIG. 4 shows a flow chart of a possible implementation of a method for encoding an input signal according to a second aspect of the present invention;

FIGS. 5A, 5B show signal diagrams for illustrating an example of a transient signal and a corresponding decoded signal for illustrating a problem underlying the present invention;

FIG. 6 shows a diagram for illustrating window switching and a possible mechanism for transient signal encoding as employed by a possible implementation of the apparatus and method according to the first or second aspect of the present invention;

FIG. 7 shows a block diagram of a transient signal encoder and a short window DCT as employed in a possible implementation of the apparatus according to the first aspect of the present invention;

FIG. 8 shows a block diagram for illustrating transient encoding based on transient parameter, sinusoidal parameter and time/frequency envelope extraction as employed in a possible implementation of the apparatus according to the first aspect of the present invention; and

FIGS. 9A, 9B show diagrams for illustrating possible examples of a weighting function depending on a transient position as employed in a possible implementation of the apparatus and method according to the first and second aspect of the present invention.

### DETAILED DESCRIPTION

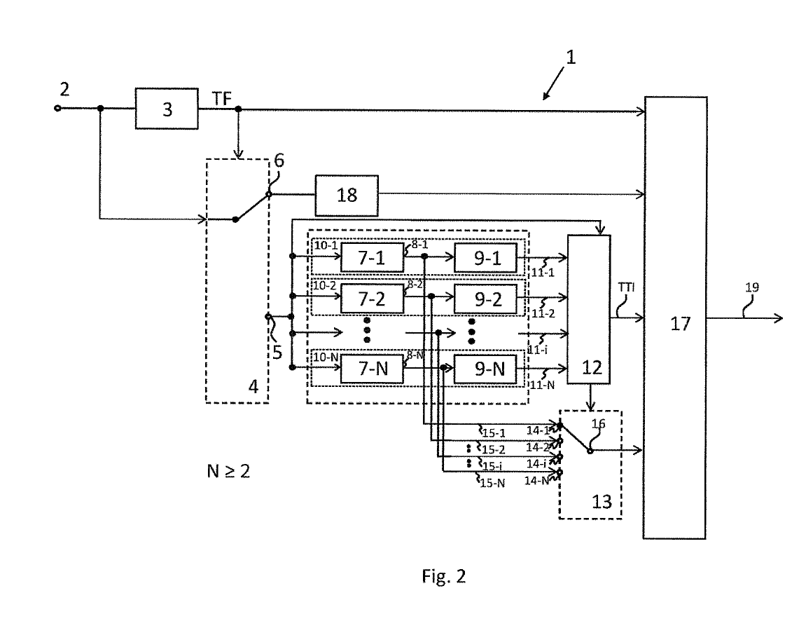

FIG. 2 shows a possible implementation of an apparatus 1 for encoding an input signal according to the first aspect of the present invention. The apparatus 1 of the shown implementation of FIG. 2 comprises a signal input 2 for receiving an input signal from a signal source. The input signal applied to the signal input 2 of the apparatus 1 can be an audio signal. The input signal is applied to a transient detector 3 within the apparatus 1, wherein the transient detector 3 is adapted to detect whether the applied input signal comprises a transient or not. In the implementation shown in FIG. 2 the transient detector 3 generates a transient flag TF which is set to logical high if the input signal comprises a transient. The transient flag TF generated by the transient detector 3 is used to control a switch 4 of the apparatus 1 as shown in FIG. 2. The apparatus 1 is switchable between two operation modes depending on whether the applied input signal comprises a transient or not. If the input signal comprises a transient the transient flag TF is set to logical high and switches the switch 4 such that the node 5 is directly connected to the signal input 2 of the apparatus 1. On the contrary, if the input signal does not comprise a transient the transient flag TF is set to logical low and the switch 4 is controlled such that node 6 is directed to the signal input 2 of the apparatus 1.

FIG. 2 shows the apparatus 1 in a mode where the input signal does not comprise a transient. If a transient is detected by the transient detector 3 the switch 4 is switched from node 6 to node 5 to which a group of transient signal encoders 7-1, 7-2 . . . 7-N are connected. Accordingly, the apparatus 1 comprises at least two transient signal encoders 7-i adapted to encode the applied input signal if a transient is detected by the transient detector 3. As shown in the implementation of FIG. 2 the apparatus 1 comprises N transient signal encoders 7-i.

FIG. 2 shows an implementation for a selection of the transient signal encoder 7-i which is performed in a closed loop. Each transient signal encoder 7-i encodes the applied input signal according to a corresponding encoding mechanism or encoding algorithm and outputs the encoded signal via a signal line 8-i to a corresponding transient signal decoder 9-i. Each transient signal encoder 7-i forms with a correspondent transient signal decoder 9-i a codec unit 10-i. Consequently, the apparatus 1 shown in the implementation of FIG. 2 comprises N codec units 10-i each having a transient signal encoder 7-i and a transient signal decoder 9-i, wherein the input of the transient signal decoder 9-i is connected to the output of the corresponding transient signal encoder 7-i as shown in FIG. 2. The decoded signal output by a transient signal decoder 9-i is supplied via a signal line 11-i to a selection unit 12 of the apparatus 1. The selection unit 12 is adapted to select a transient signal encoder 7-i among the N transient signal encoders according to at least one predetermined selection criterion. In the shown implementation of FIG. 2 the selection unit 12 is adapted to select the transient signal encoder by employing a closed loop selection mechanism for selecting the transient signal encoder 7-i within a codec unit 10-i where the corresponding transient signal decoder 9-i supplies the selection unit 12 with the decoded transient signal having the highest signal quality. The selection unit 12 controls in the shown implementation a further switch 13 having several input nodes 14-i and one output node 16. Input nodes 14-i are connected via signal lines 15-i to the outputs or output lines 8-i of the different transient signal encoders 7-i as shown in FIG. 2. The output node 16 of the switch 13 is connected to an input of a multiplexing device 17. The selection unit 12 detects and selects the transient signal encoder 7-i among the group of transient signal encoders whose corresponding transient signal decoder 9-i provides the selection unit 12 with the decoded signal having the best signal quality. For example, if the transient signal decoder 9-2 provides the selection unit 12 with a decoded signal having the highest signal quality the selection unit 12 controls the switch 13 such that the input node 14-2 is connected to the output node 16 of the switch 13 so that the output signal of the transient signal encoder 7-2 is applied via the switch 13 to the multiplexing unit 17. In this way the quantized parameters output by the selected transient signal encoder 7-i are applied to the multiplexing unit 17. In a possible implementation the node 5 of the switch 4 is also connected directly to an input of the selection unit 12 so that the selection unit 12 further receives the input signal applied to the input terminal 2 of the apparatus 1 in case that the transient has been detected to evaluate the decoded signals via lines 11-1 to 11-N to decide which decoded signal comprises the highest signal quality.

The selection unit 2 is further adapted to output an transient type indicator (TTI) to the multiplexing unit 17, wherein the transient type indicator indicates the type of the selected transient encoding, for example, by comprising the index i of the codec 10-i as shown in FIG. 2. The selection signal (see arrow pointing from section unit 12 to switch 13) may be the transient type indicator TTI or any other suitable signal.

As can be seen in FIG. 2 the apparatus 1 further comprises at least one non-transient signal encoder 18 which is adapted to encode the input signal if the transient detector 3 does not detect a transient in the input signal. In this case, the transient detector 3 controls the switch 4 such that the input of the switch 4 is connected to node 6. In the implementation shown in FIG. 2 the apparatus 1 comprises a multiplexer 17 adapted to multiplex the encoded transient signal output by the selected transient signal encoder 7-i or the encoded non-transient signal output by the non-transient signal encoder 18 as well as the transient indication flag TF generated by the transient detector 3 and the transient type indicator TTI output by the selection unit 12 onto a communication channel 19.

The at least two transient signal encoders 7-i of the apparatus 1 are adapted to perform the encoding of the signal input 2 of the apparatus 1 by using different transient encoding mechanisms. These transient encoding mechanisms can comprise window switching, a short window DCT or can be based on transient parameters, sinusoidal parameter and time/frequency envelope extraction.

The selection unit 12 can use one or more selection criteria to select a transient signal encoder 7-i among the group of transient signal encoders. A possible selection criterion used by the selection unit 12 can be a signal to noise ratio SNR. A further possible selection criterion used by the selection unit 12 can be a segmental signal to noise ratio SSNR. A further possible selection criterion used by the selection unit 12 can be a weighted segmental signal to noise ratio or a pre-echo signal energy. In these cases, the decoded transient signal having the highest signal quality or the best quality will be defined as the decoded transient signal having the highest signal to noise ratio or segmental signal to noise ratio or the lowest pre-echo signal energy, which indicates a better reconstruction of the original signal with less quantization noise.

In a possible implementation the transient detector 3 of the apparatus 1 can be adapted to detect whether the input signal is a transient audio signal or not. If the input signal is classified by the transient detector 3 as comprising a transient, two or more transient encoding mechanisms as well as their corresponding local decoding mechanisms can be applied to the input signal and the quality of the decoded signals is compared by the selection unit 12 according to at least one predetermined quality selection criterion. Based on this selection criterion one of the encoding mechanisms as employed by the transient signal encoders 7-i is selected. The selection can be based on the signal to noise ratio SNR, the weighted signal to noise ratio or other objective quality measurement criteria. The codec unit 10-i providing the signal with the best quality is selected by the selection unit 12 and its parameters are used to generate the encoded signal. As can be seen in FIG. 2 the N transient encoders 7-i and their corresponding decoders 9-i process the signal in parallel and the quality of the N decoded signals is evaluated by the selection unit 12. The quantized parameters produced by the transient encoder 7-i achieving the best quality performance according to the quality criterion used by the selection unit 12 are then used to generate the bit stream of the encoded signal output by the multiplexing unit 17 to the communication channel 19.

In a possible implementation the selection criterion used by the selection unit 12 can be based on a segmental SNR in a current encoded frame, with more weight on the signal before the transient. In this implementation the position of the transient can be detected by the transient detector 3 as well. In this implementation the detected position of the transient is detected and sent to a quality evaluation and comparison module within the selection unit 12 to adapt the quality selection criterion. The segmental signal to noise ratio SSNR can be defined as an average of a signal to noise ratio SNR values over a plurality of signal segments L as follows:

$$SSNR = \frac{1}{L} {\sum }_{i\_ 0}^{L - 1} ( 10 log \frac{{\sum }_{n = 0}^{M - 1} {S}_{i}^{2} [ n ]}{{\sum }_{n = 0}^{M - 1} {n}_{i}^{2} [ n ]} )$$

wherein L is the number of segments, M is the number of samples per segments and s represents the input signal and n the quantization noise.

In a possible implementation in order to better adapt the objective selection criterion to a specific signal characteristic of a transient a different weight can be applied before and after the transient position as follows:

$$SSNR = \frac{1}{2} ( {w}_{1} 10 log \frac{{\sum }_{n = 0}^{M 2 - 1} {s}_{0}^{2}}{{\sum }_{n = 0}^{M 2 - 1} {n}_{0}^{1}} + {w}_{2} 10 log \frac{{\sum }_{n = {M}_{1}}^{M - 1} {s}_{1}^{2} [ n ]}{{\sum }_{n = {M}_{1}}^{M - 1} {n}_{1}^{2} [ n ]} )$$

with w1+w2=2 and w1>w2, wherein M1 is the position of the transient in the current frame.

A temporal masking effect in the auditory system can affect the perception of the quantization noise before the transient. During a short period before the actual transient position a noise will not be perceived if its energy stays below a certain threshold. This property can also be used as a selection criterion. In a possible implementation the current frame can be decomposed in several segments for the computation of the segmental signal to noise ratio SSNR, wherein a different weight can be applied according to a pre-masking as follows:

$$SSNR = \frac{1}{L} ( \begin{matrix}{\sum }_{i = 0}^{{L}_{1} - 1} ( {w}_{1} 10 log \frac{{\sum }_{n = 0}^{M - 1} {s}_{i}^{2} [ n ]}{{\sum }_{n = 0}^{M - 1} {n}_{i}^{2} [ n ]} ) + {\sum }_{i = {L}_{1}}^{{L}_{2} - 1} ( {w}_{pre} 10 log \frac{{\sum }_{n = 0}^{M - 1} {s}_{i}^{2} [ n ]}{{\sum }_{n = 0}^{M - 1} {n}_{1}^{2} [ n ]} ) + \\ {\sum }_{i = {L}_{2}}^{L - 1} ( {w}_{2} 10 log \frac{{\sum }_{n = 0}^{M - 1} {s}_{1}^{2} [ n ]}{{\sum }_{n = 0}^{M - 1} {n}_{1}^{2} [ n ]} )\end{matrix} )$$

where L1 is the position of the start of the pre-masking effect,

L2 is the position of the detected transient.

In a further possible embodiment of the apparatus 1 according to the first aspect of the present invention the selection unit 12 as shown in FIG. 2 performs a quality evaluation and comparison based on the segmental signal to noise ratio SSNR. In a possible implementation the selection unit 12 receives as an input signal also a transient position from the transient detector 3.

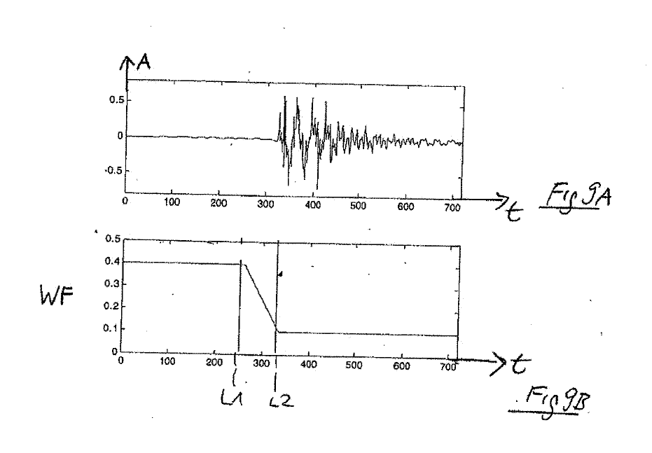

FIGS. 9A, 9B show an example of a weighting function depending on a transient position provided by the transient detector 3 to the selection unit 12. FIG. 9A shows an input signal comprising a transient signal or transient signal portion. The occurrence of a transient is also referred to as attack of a transient. The amplitude of the signal is shown over time in FIG. 9A. FIG. 9B shows an exemplary implementation of a shape of a weighting function WF applied to the weighted segmental signal to noise ratio SSNR calculation as performed by the selection unit 12. Between the values L1, L2 the amplitude of the weighting function WF drops in the shown example from a value of 0.4 to a value of 0.1, wherein L1 is a position of the start of the pre-masking effect and L2 is the position of the detected transient. As can be seen in FIG. 9B an emphasis is put on the signal part prior to the detected transient position L2 supplied by the transient detector 3 to the selection unit 12. The weighting function WF such as shown in FIG. 9B applies different weighting factors before and after the detected transient position detected by the transient detector 3. The weighting function WF can be stored in a local memory of the apparatus 1. In a possible implementation switching between different weighting functions WF according to different operation modes is possible.

In a further possible embodiment of the apparatus 1 for encoding an input signal according to the first aspect of the present invention as shown in the block diagram of FIG. 2 the selection unit 12 can perform a quality evaluation and a comparison based on pre-echo energy detection. In this embodiment the selection criterion is based on the control of the pre-echo energy. In this implementation a time envelope of the different transient coding mechanisms employed by the transient signal encoders is estimated and the method injecting less energy prior to the transient is selected. Accordingly, in this implementation an encoding mechanism introducing less pre-echo is selected by the selection unit 12.

In a possible embodiment different selection mechanisms can be implemented in the selection unit 12 and the desired selection mechanism can be activated in response to a corresponding control signal. In this implementation the apparatus 1 can be switched between different operation modes within the selection unit 12 using different selection criteria and also different selection mechanisms depending on an operation mode of the apparatus 1. The closed loop selection approach used by the implementation shown in FIG. 2 applies different encoding and corresponding decoding mechanisms to the input signal before a selection is made by the selection unit 12.

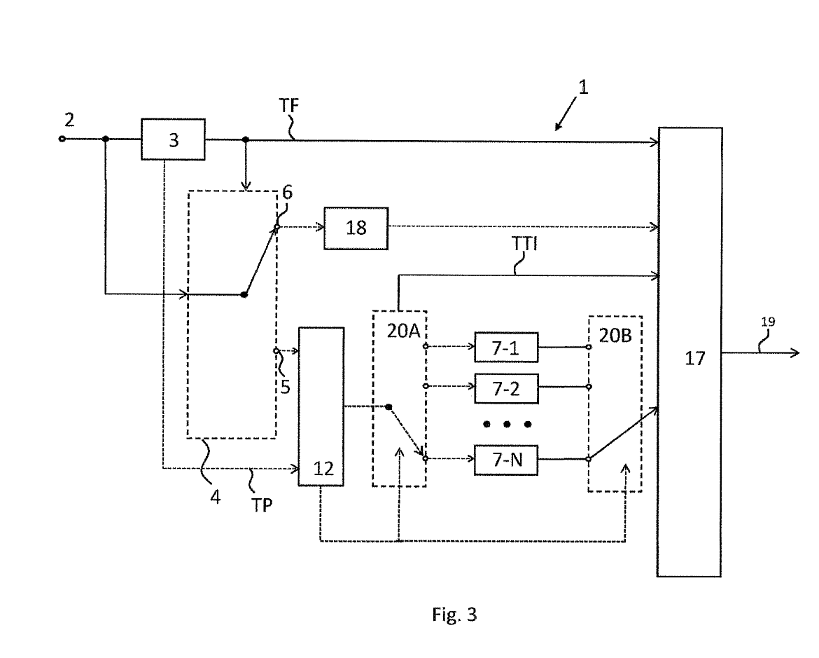

In a further alternative embodiment of the apparatus 1 for encoding an input signal according to the first aspect of the present invention the selection unit 12 is adapted to perform an open loop selection of a transient signal encoder 7-i of a plurality N of different transient signal encoders 7-i, wherein i=1 . . . N. FIG. 3 shows a block diagram for a possible implementation of an apparatus 1 with an open loop transient signal encoder selection which can be for example based on a transient position and pre-echo energy detection. As can be seen in FIG. 3 the apparatus 1 in the implementation of FIG. 3 comprises a group of transient signal encoders 7-i similar to the implementation shown in FIG. 2. In contrast to the implementation shown in FIG. 2 the apparatus 1 of FIG. 3 performs an open loop selection by means of a selection unit 12 which is directly connected to the node 5 of the switch 4 receiving the input signal from the input terminal 2 of the apparatus 1 in case that the transient detector 3 detects that the input signal comprises a signal transient. As can be seen in FIG. 3 the selection of a transient signal encoder among the transient signal encoders is performed in advance by the selection unit 12 based on predetermined selection criteria by controlling switches 20A, 20B. In a possible implementation the pre-selection of the different transient signal encoders 7-i is based on a transient position and/or a transient energy of the input signal. In the implementation shown in FIG. 3 the transient detector 3 supplies the transient position TP to the pre-selection unit 12. In the implementation shown in FIG. 3 the performance of each transient coding mechanism and each corresponding transient signal encoder 7-i is known based on the input signal and the transient position TP of the transient. In the implementation of FIG. 3 the selection of the transient signal encoder 7-i is made based on the transient signal characteristics comprised in the input signal. Depending on the transient position amplitude a pre-ranking of usable transient encoding mechanisms and their performance can be derived. Depending on the transient position TP of the transient a corresponding best-fitting transient encoding mechanism is activated. If the transient is detected by the transient detector 3 the selection of the most appropriate transient encoder 7-i is done a priori based on the available signal information. In a possible implementation the transient position TP and/or transient energy, i.e. a ratio of energy before and after the transient position TP can be used as selection criterion by the pre-selection unit 12. In a possible embodiment in order to obtain this a priori classification a training process can be performed based on one or a combination of the closed loop transient selection embodiments. In this implementation the training process does aim to identify a selection criterion such as transient position TP which does lead to a closed loop selection of one of the transient encoders. Once these selection criteria are identified in order to differentiate the transient encoders the selection of the transient encoders 7-i can be performed by open loop selection such as shown in FIG. 3 to save computational complexity.

The implementation shown in FIG. 3 has the advantage that no transient signal decoders 9-i are necessary or have to be activated so that the complexity and energy consumption of the circuit of the apparatus 1 can be reduced in comparison to the implementation shown in FIG. 2.

As described with regards to FIG. 2, the transient detector 3 is adapted to output the transient flag TF and the selection unit 12 is adapted to output the transient type indicator (TTI) to the multiplexing unit 17. The selection signal (see broken line arrow pointing from section unit 12 to switches 20A and 20B) may be the transient type indicator TTI or any other suitable signal. The multiplexing unit 17 is adapted to multiplex the transient flag TF, the transient type indicator TTI and the encoded signal, encoded by the non-transient signal encoder 18 or by one of the transient signal encoders 7-i, into one bitstream.

In a still further possible implementation the open and closed loop selection as shown in FIGS. 2 and 3 can be combined. Based on the transient position TP the open loop selection can be used with a limited number of pre-selected transient encoding mechanisms applied to the signal. In this implementation the closed loop selection is then obtained from the limited list of pre-selected transient encoding mechanisms.

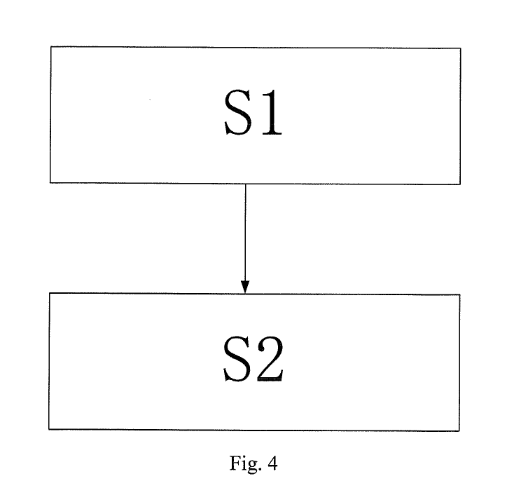

FIG. 4 shows a flow chart of a possible implementation of a method for encoding an input signal according to the second aspect of the present invention.

In a first step S1 it is detected whether an input signal comprises a transient or not. This detection can for example be performed by a transient detector 3 as shown in FIG. 2, 3.

In a further step S2 a transient signal encoder 7-i among a group of transient signal encoders is selected according to at least one predetermined selection criterion if a transient is detected in the input signal in step S1. In a possible implementation of the method according to the second aspect of the present invention as shown in FIG. 4 the selection of the transient signal encoder is performed in a closed loop selection in step S2 as described based on FIG. 2. In an alternative implementation of the method for encoding an input signal according to the second aspect of the present invention as shown in FIG. 4 the selection of the transient signal encoder 7-i is performed as an open loop selection of the transient signal encoder in step S2 as described based on FIG. 3.

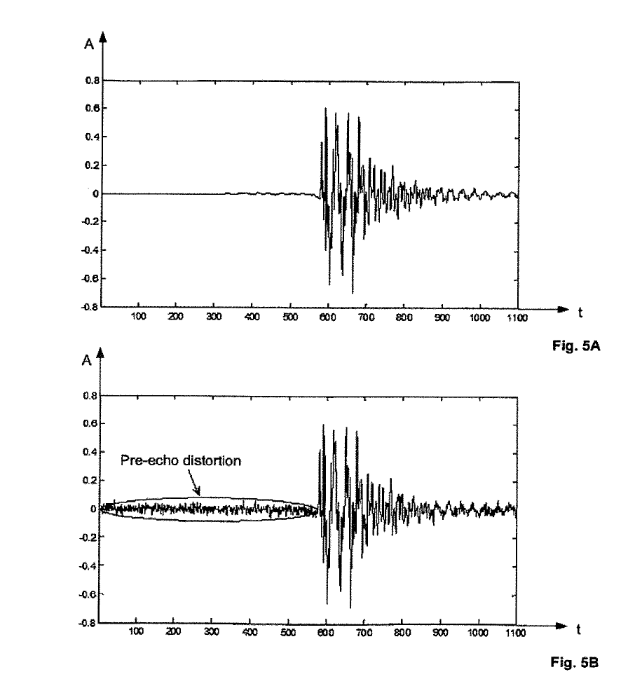

FIGS. 5A, 5B show signal diagrams for illustrating the functionality of the apparatus and method for encoding an input signal according to the first and second aspect of the present invention.

FIG. 5A shows an exemplary input signal having an amplitude A over time t. FIG. 5A shows the samples over time. As can be seen there is a region of low signal energy until about sample 550 forming a stationary signal. Then a sharp attack occurs with a high amplitude which for example can be caused by a percussion instrument such as castanets or Glockenspiel. In a block-based algorithm when quantizing the transform coefficients the inverse transform at the decoder side does spread the quantization noise distortion evenly in time as illustrated by FIG. 5B. This results in an unmasked distortion on the low energy region preceding in time the signal attack as illustrated by FIGS. 5A, 5B. A conventional temporary pre-masking has the potential to mask the distortion, however, this in only possible when the transform block size is sufficiently small such that pre-masking is possible. Consequently, a handling of such signal transients as shown in FIG. 5A is necessary and is provided by a selected transient signal encoder 7-i within the apparatus 1 according to the present invention.

As can be seen in the implementation of FIGS. 2, 3 the selection unit 12 is adapted to select a transient signal encoder 7-i among a group of transient signal encoders according to at least one predetermined selection criterion. The different transient signal encoders can employ different encoding mechanisms to encode the transient signal.

In a possible embodiment a transient signal encoder 7-i within the group of N transient signal encoders 7-i performs window switching.

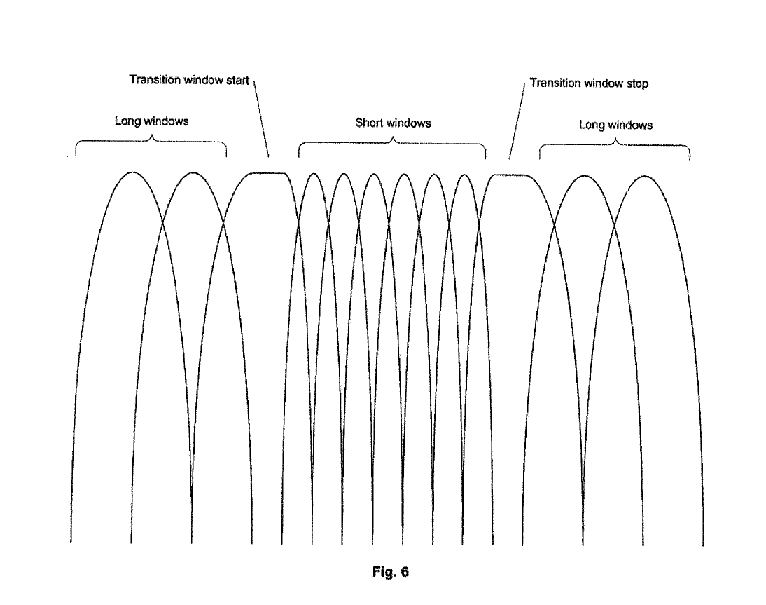

FIG. 6 shows a diagram for illustrating window switching as employed by a transient signal encoder 7-i according to a possible implementation of the apparatus 1 according to the first aspect of the present invention. Window switching is performed for pre-echo suppression in particular in the case of using a MDCT based transform coding algorithm. Window switching is based on the idea of changing a time resolution of the transform upon detection of a transient in the input signal. Typically this involves changing the analysis block length from a long duration during stationary signals to a short duration when transients are detected in the input signal. FIG. 6 shows a simple diagram of a transform coder applying a block switching or window switching principle. The first transient detection algorithm can be used to detect a transient or attack in the input signal. In order to be able to anticipate a change of window length the input signal can be delayed before being encoded. If no transient is detected by the transient detector 3 a stationary mode with long block and long window is used. If a transient is detected in the input signal the stationary mode is used with a start window as illustrated in FIG. 6. This window allows to have a transition between a long and a short window. The short windows are used as long as a transient is detected by the transient detector 3. Once the transient detector 3 indicates a normal signal, i.e. a signal without any transient, the stationary mode with a stop window is used. A delay can occur because in the block-switching coding scheme a transition window is necessary between the long and short windows. It is then necessary to detect the transient in advance in order to be able to insert a transition window before the transient starts in the input signal. The short window applied to the short frame containing the transient does minimize the temporal spread of coding noise and allows temporal pre-masking to take effect and render the distortion inaudible to a user. Further, higher bitrates can be allocated to the short temporal regions containing the signal transient.

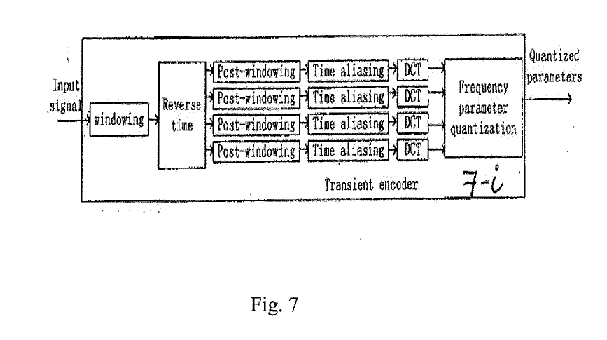

Although window switching is an efficient transient signal encoding mechanism it can be less efficient than other mechanisms under certain conditions and situations. By using window switching the perceptual model and lossless coding modules of the codec unit have to support different time resolutions which translate usually into increased complexity of the apparatus 1. In addition, when using lapped transforms such as the MDCT in order to satisfy the construction constraints window switching needs to insert transition windows between short and long blocks as illustrated in FIG. 6. Therefore, the need for transition windows does increase a delay due to the fact that the switching of the windows cannot be done instantaneously. Further, the relatively poor frequency localization properties of transition windows lead to a reduction encoding gain. Consequently, other transient signals encoding mechanisms can lead to a more efficient encoding such as a transient encoder 7-i based on a short window DCT as illustrated in FIG. 7. Such a transient encoding mechanism is for example used in a full-band audio codec G.719 recommendation, G.719: “Low complexity, full-band audio encoding for high quality, conversational applications”, ITU recommendation (06/2008).

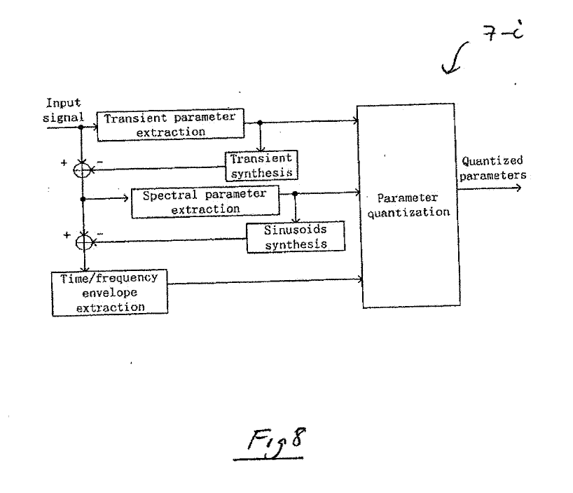

Another possible transient signal encoder 7-i or transient signal encoding mechanism which can be used by the apparatus 1 according to the present invention can be based on transient modeling, sinusoidal parameter and time/frequency envelope extraction as illustrated in FIG. 8. This transient encoding mechanism is for example also used in MPEG-4 SSC (SinuSoidal Coding) as for example explained by A. C. den Brinker, E. Schuijers, W. Oomen, “Parametric Coding for High-Quality Audio”, 112th AES Convention, April 2002, Preprint 5554.

The number and types of the transient encoders 7-i as employed by the apparatus 1 are not limited. They can be chosen among different encoding models such as transform coding, transient, sinusoidal coding, CELP, etc.

The transient encoders 7-i do ensure a reconstruction with the adjacent frames. In a possible implementation the selected transient encoder is signaled to the decoder in the bit stream with the corresponding quantized parameters. In this implementation the multiplexing unit 17 does also multiplex an indication or an identifier of the selected transient encoder into the bit stream supplied to the decoder via the communication channel 19.

An embodiment of an apparatus for decoding, or a decoder, receives the bit stream comprising the encoded signal, the transient flag TF and the transient type indicator TTI. Accordingly, an embodiment of the decoder comprises a receiver, at least two transient signal decoders and a selection unit. The receiver is adapted to receive the encoded signal, the transient indication and the transient type indication, wherein the transient indication indicates, whether the encoded signal is a transient signal or a non-transient signal, and wherein the transient type indication indicates a type of transient coding in case the transient indication indicates that the encoded signal is a transient signal. The selection unit is adapted to select a transient decoder among the at least two transient decoders based on the transient type indicator to decode the encoded transient signal in case the transient indication indicates that the encoded signal is a transient signal.

Different methods for encoding an input signal can be used for encoding an audio input signal. The apparatus and method allow codec units to provide an efficient reduction of pre-echo artifacts in case of transient audio signals and do improve the overall signal quality for this type of signal. The apparatus 1 as shown in the implementation of FIG. 2, 3 is comprised of several entities and units which can be implemented in hardware and/or software components. The apparatus 1 according to the first aspect and the method for encoding a signal according to the second aspect of the present invention can be used for encoding any kind of digital input signal, in particular an audio signal but also other signals such as video signals or the like. The apparatus and method according to the present invention can be used for any kind of audio systems for example conferencing systems. The apparatus and method according to the present invention can be applied in monophonic audio encoding and decoding systems as well as for multichannel audio encoding and decoding systems, wherein the stereo encoding and decoding just forms a specific implementation of the multi-channel encoding and decoding. In case of discrete multichannel audio encoders and decoders, relying on several monophonic audio encoders and decoders used for encoding separately the different channels of the multichannel signal, the apparatus or method according to the present invention can be used in each of the plurality of monophonic audio encoders and decoders. In case of parametric multichannel audio encoders and decoders relying on spatial parameter extraction and at least one monophonic audio encoder encoding a downmix signal representing the audio content of the multichannel audio signal, the apparatus or method according to the present invention can be used in the monophonic audio encoder and decoder used to encode and decode the downmix signal.

In a possible implementation the transient detector 3 detects a transient within the applied input signal by performing a high-pass filtering of the input signal for example by means of a first order IIR filter. The high-pass filtered signal can then be sectioned into sub-frames and the energy for each sub-frame can be computed. For each sub-frame a comparison between a short term energy and a long term energy can be performed. A transient of a signal is then detected by the transient detector 3 whenever the energy ratio between the short term energy and the long term energy is above a certain threshold.

Although embodiments of the invention have been described primarily based on transient flags and transient type indicators being separate indicators, see for example FIGS. 2 to 4, embodiments of the apparatus and methods for encoding and decoding can be adapted to use, send or receive a joint transient indicator or joint transient indication field comprising the information of the transient indication or flag and of the transient type indicator, wherein a first value of the joint transient indicator indicates that the encoded signal is a non-transient signal, a second value indicates that the encoded signal is a transient signal encoded according to a first transient codec, a third value indicates that the encoded signal is a transient signal encoded according to a second transient codec, and so on.

Furthermore, although embodiments have been described, wherein the encoded signal, the transition indication and the transition type indication are multiplexed into one bit stream, other embodiments of the encoder can be adapted to send these data via different channels, e.g. to the decoder or to a storage medium, and other embodiments of the decoder can be adapted to receive these data via different channels, e.g. from an encoder or from a storage medium.

What is claimed is:

1. An apparatus for encoding an input signal applied to said apparatus, the apparatus comprising:
a transient detector adapted to detect whether the applied input signal comprises a transient;
at least two transient signal encoders adapted to encode the applied input signal if a transient is detected by the transient detector; and
a selection unit adapted to select a transient signal encoder among the at least two transient signal encoders according to at least one predetermined selection criterion.

2. The apparatus according to claim 1,
wherein the transient detector is adapted to detect a transient position and/or transient energy of a transient of the input signal applied to said apparatus.

3. The apparatus according to claim 1,
wherein the selection unit is adapted to perform a closed loop selection or an open loop selection of the transient signal encoder.

4. The apparatus according to claim 1,
wherein the selection unit is adapted to perform a closed loop selection by selecting the transient signal encoder within a codec unit comprising the transient signal encoder and a corresponding transient signal decoder which supplies said selection unit with the decoded transient signal having the highest signal quality.

5. The apparatus according to claim 3,
wherein the selection unit is provided for performing an open loop selection by selecting the transient signal encoder among the at least two transient signal encoders depending on the transient position and/or transient energy of the applied input signal detected by the transient detector.

6. The apparatus according to claim 1,
wherein the at least two transient signal encoders are adapted to perform the encoding of the input signal by using different transient encoding mechanisms comprising window switching, short window DCT or based on transient parameters, sinusoidal parameter and time/frequency envelope extraction.

7. The apparatus according to claim 1,
wherein the at least one selection criterion used by the selection unit comprises a signal to noise ratio SNR and/or a segmental signal to noise ratio SSNR and/or a weighted segmental signal to noise ratio and/or a pre-echo signal energy.

8. The apparatus according to claim 7,
wherein the selection unit is adapted to calculate the weighted SSNR using a weighting function stored in a local memory of the apparatus.

9. The apparatus according to claim 8,
wherein the weighting function applies different weighting factors before and after the detected transient position detected by the transient detector.

10. The apparatus according to claim 1,
wherein the apparatus comprises a non-transient signal encoder adapted to encode the input signal if the transient detector does not detect a transient in the input signal;
wherein the transient detector generates a transient indication, for example a transient flag, TF, indicating whether a transient has been detected by the transient detector or not; and
wherein the selection unit is adapted to control a switch to select a transient signal encoder among the transient signal encoders according to the at least one predetermined selection criterion.

11. The apparatus according to claim 1,
wherein the apparatus comprises a multiplexer adapted to multiplex the encoded transient signal output by the selected transient signal encoder or an encoded non-transient signal, the transient indication generated by the transient detector and a transient type indication, TTI, generated by the selection unit onto a communication channel, wherein the transient type indication indicates the type of the transient coding in case the transient indication indicates that the encoded signal is a transient signal.

12. An apparatus for decoding, the apparatus comprising:
a receiver adapted to receive an encoded signal, a transient indication and a transient type indication associated to the encoded signal, wherein the transient indication indicates, whether the encoded signal is a transient signal or a non-transient signal, and wherein the transient type indication indicates a type of transient coding in case the transient indication indicates that the encoded signal is a transient signal;
at least two transient signal decoders; and
a selection unit to select a transient signal decoder among the at least two transient signal decoders based on the transient type indicator to decode the encoded transient signal incase the transient indication indicates that the encoded signal is a transient signal.

13. A method for encoding an input signal, the method comprising:
detecting whether the input signal comprises a transient; and
selecting a transient signal encoder among a group of transient signal encoders according to at least one predetermined selection criterion if a transient is detected in the input signal.

14. The method according to claim 13,
wherein selecting the transient signal encoder is performed as a closed loop selection or as an open loop selection of the transient signal encoder.

15. A method for decoding, the method comprising:
receiving an encoded signal, a transient indication and a transient type indication, wherein the transient indication indicates, whether the encoded signal is a transient signal or a non-transient signal, and wherein the transient type indication indicates a type of transient coding in case the transient indication indicates that the encoded signal is a transient signal; and
selecting a transient signal decoder among at least two transient signal decoders based on the transient type indicator to decode the encoded transient signal in case the transient indication indicates that the encoded signal is a transient signal.
